(19) United States
(12) Patent Application Publication
(10) Pub. No.: US 2025/0171095 A1
(43) Pub. Date: May 29, 2025

(54) METHOD AND APPARATUS FOR CONTROLLING ELECTRIC TWO-WHEELED VEHICLE

(71) Applicant: Hyundai Kefico Corporation, Gunpo, Gyeonggi-do (KR)

(72) Inventors: Inkeun Seo, Gunpo, Gyeonggi-do (KR); Sehee Byun, Gunpo, Gyeonggi-do (KR); Sillo Jin, Gunpo, Gyeonggi-do (KR); Hyunseung Kim, Gunpo, Gyeonggi-do (KR)

(21) Appl. No.: 18/834,795

(22) PCT Filed: Jul. 7, 2021
(86) PCT No.: PCT/KR2021/008667

§ 371 Date: Jul. 31, 2024

(30) Foreign Application Priority Data
Jul. 7, 2020 (KR) 10-2020-0083717

(51) Int. Cl. B62H 5/08; B62H 5/20

(52) U.S. Cl. CPC B62H 5/08; B62H 5/20

(57) ABSTRACT

The present disclosure relates to a control method for an electric two-wheeled vehicle, which includes: checking a key-on state and a user authentication state; determining a suspected theft state if a key-off state occurs or user authentication is released; controlling. an inverter to output a direct current power to a motor when a state of the electric two-wheeled vehicle is determined as the suspected theft state; and notifying a driver of the suspected theft state.

### TECHNICAL FIELD

The present disclosure relates to a control method and device for an electric two-wheeled vehicle, which are capable of preventing the two-wheeled vehicle from being stolen.

### BACKGROUND ART

The present disclosure relates to a control device for an electric scooter.

An electric two-wheeled vehicle such as an electric scooter is a small personal two-wheeled transportation means that moves by using a motor driven by a battery.

A conventional electric scooter control device has a power supply, a key operation unit, a control unit, a motor drive unit (inverter), and a display unit.

The power supply applies power for driving the scooter to the scooter, and the key operation unit receives various key inputs for controlling the scooter. The motor drive unit (inverter) drives the motor of the scooter, and the display unit displays various operation states of the scooter. The control unit performs overall control of the device.

In other words, when the power of the scooter is turned on by the power supply, the motor is driven by controlling the motor drive unit (inverter) through the control unit by key operation through the key operation unit, so that the scooter moves. Also, various operation states of the scooter are displayed through the display unit.

The electric two-wheeled vehicle such as an electric scooter is lighter in weight than a conventional motorcycle, so that there is a high possibility that the electric two-wheeled vehicle is stolen. In particular, unlike engines, it is difficult to equip the motor itself with a separate anti-theft locking device, and if the anti-theft locking is performed by a brake system, the durability of elastic components (a compression spring, etc.) constituting the brake system is degraded.

A motor drive system in the electric two-wheeled vehicle according to a conventional technology does not present any specific measures or methods for theft prevention.

### DISCLOSURE

### Technical Problem

The purpose of the present disclosure is to provide a control method and device for an electric two-wheeled vehicle, which is capable of effectively preventing theft by adding a relatively simple control method to the motor drive system of the electric two-wheeled vehicle.

### Technical Solution

One embodiment is a control method for an electric two-wheeled vehicle, which includes: checking a key-on state and a user authentication state; determining a suspected theft state if a key-off state occurs or user authentication is released; controlling an inverter to output a direct current power to a motor when a state of the electric two-wheeled vehicle is determined as the suspected theft state; and notifying a driver of the suspected theft state.

In the determining the suspected theft state, at least one of whether the user authentication is performed, vehicle states, GPS, acceleration sensors, and a back-EMF of the motor may be used as a sensor or parameter for detecting the theft.

The determining the suspected theft state may perform at least one of checking whether a moving distance in the key-off state exceeds a predetermined distance using a GPS reception signal, detecting theft movement using a back-EMF of the motor, and detecting the generation of acceleration in a theft situation using an acceleration sensor value.

The detecting the generation of acceleration in a theft situation may determine that the vehicle is in the suspected theft state if instantaneous acceleration is generated in the direction of gravity.

In the controlling the inverter to output a direct current power to the motor, all or some of six drive switches of the inverter may be continuously turned on with a fixed direct current.

In the notifying the suspected theft state, information on the suspected theft state of the vehicle may be transmitted to a cloud server.

Another embodiment is a control device for an electric two-wheeled vehicle. The control device includes: an inverter which supplies driving power to a motor that moves the vehicle; a theft detection sensing unit which determines a suspected theft state of the vehicle; and a vehicle control unit which controls the inverter to output direct current power to the motor when the suspected theft state is recognized.

The vehicle control unit may include: a theft determination unit which determines the suspected theft state of the vehicle; a theft prevention unit which, when the vehicle is determined to be in the suspected theft state, wakes up the inverter, and then controls the motor with a fixed direct current; and a notification unit which notifies a driver and related parties of the suspected theft state.

The theft detection sensing unit may include at least one of a user authentication means, a GPS receiver sensor, and a 3-axis acceleration sensor.

The theft determination unit may determine that the vehicle is in the suspected theft when the vehicle exceeds a predetermined distance threshold based on received information of the GPS receiver sensor or when an acceleration detected by the acceleration sensor exceeds a predetermined threshold.

The theft detection sensing unit may include a forced rotation detection unit which is activated by an electromotive force for forced rotation of the motor and wakes up the inverter.

### Advantageous Effects

Through the control method and device for an electric two-wheeled vehicle according to the spirit of the present disclosure with the above-described configuration, there is an advantage of effectively preventing theft by adding a relatively simple control method to the motor drive system of the electric two-wheeled vehicle.

### DESCRIPTION OF DRAWINGS

FIG. 1 is a block diagram showing a motor drive structure of a general vehicle;

FIG. 2 is a flowchart showing a control method for an electric two-wheeled vehicle according to an embodiment of the present disclosure, which is for preventing the electric two-wheeled vehicle from being stolen; and

FIG. 3 is a block diagram showing a control device for an electric two-wheeled vehicle according to the embodiment of the present disclosure, which is for preventing the electric two-wheeled vehicle from being stolen.

### MODE FOR INVENTION

In the description of the present disclosure, while terms such as the first and the second, etc., can be used to describe various components, the components are not limited by the terms mentioned above. The terms are used only for distinguishing between one component and other components. For example, the first component may be designated as the second component without departing from the scope of rights of the invention. Similarly, the second component may be designated as the first component.

In the case where a component is referred to as being “connected” or “accessed” to another component, it should be understood that not only the component is directly connected or accessed to the other component, but also there may exist another component between them.

Terms used in the present specification are provided for description of only specific embodiments of the present invention, and not intended to be limiting. An expression of a singular form includes the expression of plural form thereof unless otherwise explicitly mentioned in the context.

In the present specification, it should be understood that the term “include” or “comprise” and the like is intended to specify characteristics, numbers, steps, operations, components, parts or any combination thereof which are mentioned in the specification, and intended not to previously exclude the possibility of existence or addition of at least one another characteristics.

Also, the shapes and sizes and the like of components of the drawings are exaggerated for clarity of the description.

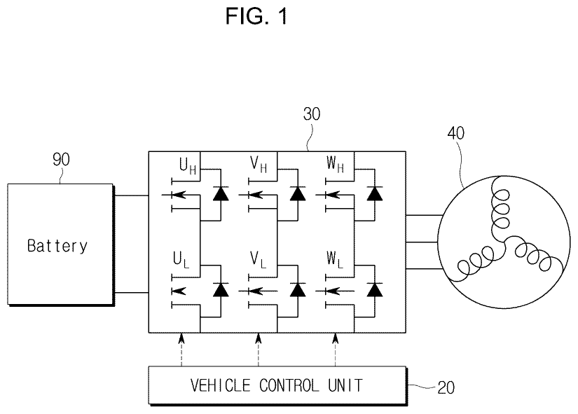

FIG. 1 is a block diagram showing a motor drive structure of a general vehicle.

The shown motor drive structure includes a battery 20, a drive motor 40, an inverter 30, and a vehicle control unit 20. They can also be applied to an electric two-wheeled vehicle.

Here, the battery 20 serves as a power supply for the electric two-wheeled vehicle, and applies driving power to the electric two-wheeled vehicle. The inverter 30 acts as a motor drive unit, and drives a motor for driving the electric two-wheeled vehicle. The vehicle control unit 20 is a processing device that performs overall control of the device of the electric two-wheeled vehicle. In relation to the spirit of the present disclosure, the vehicle control unit 20 controls the switching of a power switch device that constitutes the inverter 30.

A control method for the electric two-wheeled vehicle according to the spirit of the present disclosure, which is for preventing the electric two-wheeled vehicle from being stolen, may be performed based on the vehicle control unit 20 of FIG. 1 in such a manner that the inverter 30 continuously applies a fixed direct current power to the motor 40 in a suspected theft state.

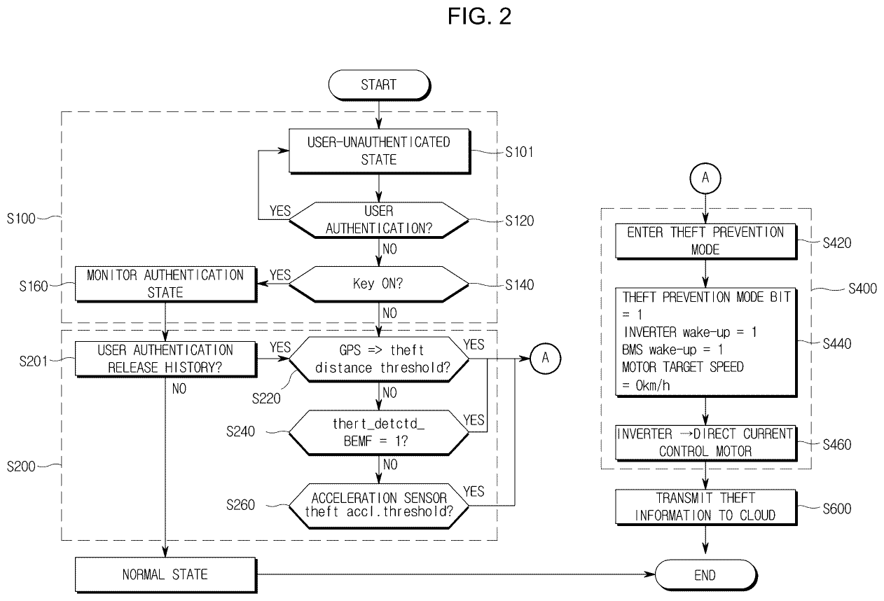

FIG. 2 is a flowchart showing a control method for an electric two-wheeled vehicle according to an embodiment of the present disclosure, which is for preventing the electric two-wheeled vehicle from being stolen.

The control method for an electric two-wheeled vehicle for theft prevention according to the embodiment shown in FIG. 2, which is for preventing the electric two-wheeled vehicle from being stolen, includes: checking a key-on state and a user authentication state (S100); determining a suspected theft state if a key-off state occurs or user authentication is released (S200); controlling such that the inverter that drives the motor outputs a direct current power when the electric two-wheeled vehicle is determined to be in the suspected theft state (S400); and notifying a driver of the suspected theft state (S600).

In the checking the key-on state and user authentication state (S100), as shown, a vehicle parking before starting waits for the user authentication first (S120) in the key-off and user-unauthenticated state (S101).

It is the key-on that is the simplest user authentication. For implementation with enhanced security, RF security chip mutual authentication in a smart key, etc., fingerprint authentication, smart card authentication, or driver smartphone authentication using Bluetooth communication, etc., can be applied as the user authentication.

When the key-on state occurs without user authentication (S140), the vehicle is in the key-on state, and the user authentication is checked again (S160). As a result, when it is checked that the user authentication is released (S201), a determination as to whether the theft occurs or not is made (S200).

In performing the determination as to the suspected theft state (S200), whether the user authentication is performed, vehicle states, GPS, acceleration sensors, and a back-EMF of the motor, etc., may be used as sensors (parameters) for detecting and determining the theft (suspected state). These parameters/sensing values are selected only from those that can determine, by minimal standby power consumption, whether the theft occurs.

In performing the theft detection/determination method, it is advantageous to also reflect information on whether the vehicle state is the key-on state or off state in terms of effective theft detection, user convenience, and power consumption prevention.

The determining the suspected theft state shown above (S200) performs checking whether a moving distance in the key-off state exceeds a predetermined distance using a GPS reception signal (S220); detecting theft movement using a back-EMF of the motor (S240); and detecting the generation of acceleration in a theft situation using an acceleration sensor value (S260), in the order listed. However, the steps can be performed in the changed order. Also, in simpler implementations, some of the steps S220 to S260 can be omitted.

Meanwhile, depending on the implementation, in step S201, the user authentication state can be released even if it is detected that the driver moves away from the vehicle by a distance larger than a predetermined distance. For example, whether the driver moves away from the vehicle can be determined by a sensing value of a driver sitting detection sensor installed in the vehicle or by the fact that a smart key or driver's smartphone is spaced from the vehicle by a distance larger than a predetermined distance.

The flowchart in FIG. 2 shows first a theft detection determination process according to the spirit of the present disclosure, which starts from a situation where the vehicle is in the key-off state, in consideration of the process starting from the parked vehicle.

In a state where the vehicle is in the key-off state and the user authentication is not performed by other means, when the location of the vehicle is spaced apart from a stored parking position by a distance larger than a predetermined distance (theft distance threshold) based on GPS information, this can be determined as a theft situation.

The user authentication may include, for example, fingerprint input through a fingerprint sensor provided in the vehicle, password input using an input means installed in the vehicle or a smartphone wirelessly connected (e.g., Bluetooth) to the vehicle, or connection of an authorized smart card to the vehicle in the case of a smart card authenticated vehicle.

Alternatively, in a state where the user authentication is not performed, when the degree of the generation of acceleration based on the acceleration sensor value is equal to or higher than a predetermined reference (theft accl. threshold), this can be determined as a theft situation. For example, it is possible to determine, based on x, y, and z axis values, whether the vehicle is towed away and stolen or is moved and stolen. If the acceleration in the direction of gravity (z axis) which is not significantly generated during the usual driving of the vehicle is generated greater than a predetermined reference, it can be determined that the vehicle is towed away and stolen.

Alternatively, when the vehicle is pulled away while the user authentication is not performed, the theft situation is determined using the back-EMF generated within the motor as a wake-up signal of the inverter, and suspected theft state information (theft_detected_BEMF) may be transmitted to the vehicle control unit. This can be simply implemented with an analog circuit or digital circuit in an inverter circuit itself without a separate theft detection device. There is an advantage of minimizing power consumed for suspected theft state monitoring.

Among the three aforementioned methods for determining the suspected theft state (i.e., vehicle movement based on GPS, acceleration, and back-EMF of the inverter), all or some (including one) can be applied depending on the implementation.

Next, shown is an example of a theft detection and determination process according to the spirit of the present disclosure, which occurs when the driver temporarily stops during driving, in the situation where the vehicle is the key-on state. A separate theft prevention process can be provided in the key-on state. However, for a simpler implementation, the state of the vehicle may be changed to the key-off state depending on predetermined conditions in the situation where the vehicle is in the key-on state, and the described theft detection and determination process in the key-off situation may be followed.

For example, when a transition from the user-authenticated state to the user-unauthenticated state is detected even if the vehicle is in the key-on state (e.g., the user moves away from the vehicle with the smart key after authentication), the state of the vehicle can be forcibly changed to the Key OFF state. When the state of the vehicle becomes the key-off state, the described theft detection and determination process in the key-off situation may be entered.

In the controlling such that the inverter outputs a direct current power (S400), first, the state of the vehicle is ultimately determined to be the suspected theft state, so that an active theft prevention sequence is entered (S420). In other words, in the theft prevention sequence, the inverter that drives the vehicle motor is woken up, and then the inverter DC-controls the motor to disturb the movement of the vehicle.

To this end, the vehicle control unit receives power from an auxiliary power storage device and waits with a minimum current in a wake-up state, and then may receive theft detection information such as GPS information, acceleration sensor information, and inverter information, etc., in the wake-up state. For example, a method of determining whether the theft occurs based on a signal received from a GPS module and of waking up the vehicle control unit may be performed.

When the vehicle is determined to be in the suspected theft state (S420), the vehicle control unit may transmit a wake-up signal and a suspected theft state bit to the inverter and a battery controller and may enter a ready state for driving the motor (S440).

The inverter in the aforementioned suspected theft state enters a theft prevention mode and DC-controls the motor to control the vehicle not to move (S460).

Depending on the implementation, the inverter memorizes the last parking position, and controls to maintain the position by flowing DC current to a phase appropriate for the position.

In the DC control step (S460), for example, among six drive switches U_{H}, U_{L}, V_{H}, V_{L}, W_{H}, and W_{L} of the inverter, two switches, that is, a high-side switch and a low-side switch, may be continuously turned on in such a way as to allow a large constant current to flow against an external force (force of a thief). Then, the vehicle can move due to the external force. However, the vehicle will not be able to move far, and a time for taking follow-up measures (the notifying the driver, etc., (S600)) can be obtained through a suspected theft state notification function.

The notifying the driver of the suspected theft state (S600) is named as such because the suspected theft state must be notified to the driver. For effective theft prevention, the suspected theft state is notified to the driver and related parties. For example, information on the state where the vehicle has been stolen may be provided to a vehicle owner (if the vehicle owner is different from the driver) and a manufacturer that sold the vehicle. More specifically, if the vehicle is determined to be stolen, this is transmitted to a cloud system so that the owner can receive it using a smart device, and the manufacturer that sold the vehicle and/or the vehicle rental service company can also access the information on the cloud.

After the notifying the driver of the suspected theft state (S600), a step in which the driver (owner) confirms the suspected theft state and sets to prevent the vehicle from being driven may be further included.

For example, in the confirming the suspected theft state and setting to prevent from being driven, if the vehicle owner receives the suspected theft state information and confirms the theft state, the vehicle owner is able to set to prevent the vehicle from being driven using a smart device. This information is then transmitted to the vehicle control unit via the cloud, and the vehicle can be locked and stop traveling. Alternatively, conversely, if the vehicle owner receives the suspected theft state information and confirms that the vehicle is not stolen, the theft prevention control according to the spirit of the present disclosure is released, and the vehicle can return to a normal state.

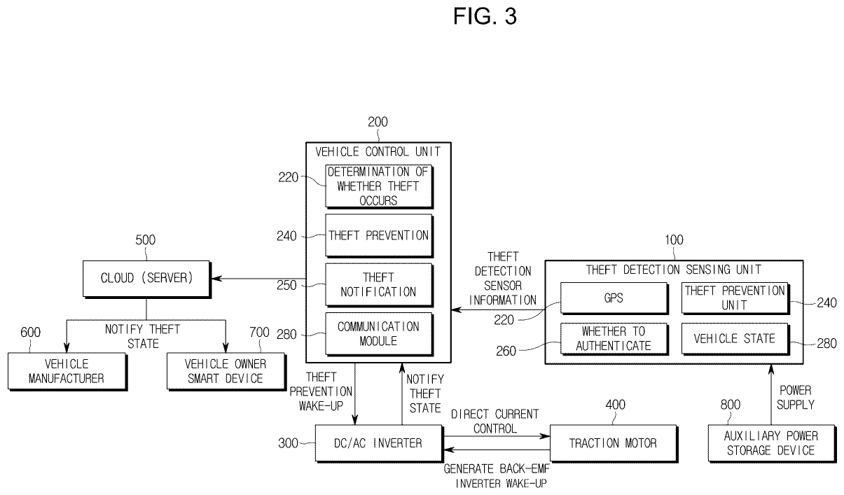

FIG. 3 is a block diagram showing a control device for an electric two-wheeled vehicle according to the embodiment of the present disclosure, which is for preventing the electric two-wheeled vehicle from being stolen.

The shown control device for an electric two-wheeled vehicle includes: an inverter 300 that supplies driving power to a motor that moves the vehicle; a theft detection sensing unit 100 that determines the suspected theft state of the vehicle; and a vehicle control unit 200 that controls the inverter to output DC power to the motor when the suspected theft state is recognized according to the spirit of the present disclosure.

The vehicle control unit 200 may include a theft determination unit 220 implemented in the form of a software module, etc., as a theft prevention system. Also, the vehicle control unit 200 may include a theft prevention unit 240 which is implemented in the form of a software module, etc., and takes measures (fixed DC control of the motor) for preventing theft in the suspected theft state.

The theft prevention unit 240 implemented in the form of a software module receives sensing values of the theft detection sensing unit 100 and determines the suspected theft state of the vehicle. If the theft prevention unit 240 determines that the vehicle is in the suspected theft state, the theft prevention unit 240 wakes up the inverter by the theft prevention sequence and then continuously control the drive motor 400 with a fixed DC, thereby preventing the movement of the vehicle.

As shown, the vehicle control unit 200 may include a communication module 250 for communicating with the inverter 300, theft detection sensing unit 100, or external devices (e.g., cloud server 500). Since the configuration of the communication module is similar to that of a general vehicle control unit, a detailed description thereof will be omitted.

The shown vehicle control unit 200 may include a notification unit 250 which is implemented in the form of software modules, etc., and notifies the driver and related parties of the suspected theft state. The notification unit 250 may not only notifies the driver of the suspected theft state through a driver notification means but also notify the vehicle owner and the manufacturer that sold the vehicle (or rental service provider) of the information on the suspected theft state of the vehicle. To this end, the notification unit 250 may transmit the information on the suspected theft state to the cloud server 500.

Various DC motors and AC motors may be applied as the motor 400. Also, a recently widely used BLDC motor has a shape optimized for the implementation of the spirit of the present disclosure.

The theft detection sensing unit 100 is for detecting/determining the suspected theft state. The theft detection sensing unit 100 may include sensors for detecting the suspected theft state (whether the user authentication is performed, vehicle states, GPS, acceleration sensors, etc.) and can determine, by minimal standby power consumption, whether the theft occurs.

Depending on the implementation, the theft detection sensing unit 100 may further include a forced rotation detection unit that is activated by an electromotive force for the forced rotation of the motor and triggers (wakes up) the motor drive unit.

The forced rotation detection unit has an advantage of being inexpensive compared to other sensor means and of being used as a rapid and effective wake-up means.

The forced rotation detection unit may be provided in the form of a sensor or circuit that detects the voltage at an inverter output terminal in such a way as to effectively detect the back-EMF generated in the coil portion of the motor. For example, the forced rotation detection unit may have the simplest form, that is, an MOS TR device of which a gate is connected to the inverter output terminal and of which an output terminal is connected to the wake-up signal terminal to the theft determination unit 220.

The theft detection sensing unit 100 may provide state information (parameters) and/or sensing values of various sensors as supporting information for detecting/determining the suspected theft state to the theft determination unit 220.

The theft determination unit 220 that has received the state information (parameters) and/or sensing values may determine that the vehicle is in the suspected theft state if the vehicle exceeds a predetermined distance threshold based on GPS information, if theft information is received from the inverter that has woken up by the generation of the back-EMF within the motor, or if the number of times of acceleration detected by the acceleration sensor exceeds a predetermined threshold.

When the vehicle is determined to be in the suspected theft state, the theft prevention unit 240 may prevent the vehicle from easily moving due to an external force by using minimal standby power consumption and by DC-controlling the motor, thereby preventing theft. Also, the notification unit 250 may activate a notification system which notifies the suspected theft state to the vehicle manufacturer and vehicle owner.

According to the notification system, the fact that the vehicle is in the theft state is transmitted to the cloud 500, and the vehicle owner may receive/check it using a smart device 700. Similarly, a server 800 of the manufacturer that sold the vehicle and/or the vehicle rental service company may also access the information on the cloud 500 and check the fact that the vehicle is in the theft state.

Depending on the implementation, the owner may use the smart device 700 to confirm the suspected theft state and set driving prohibition. For example, if the vehicle owner receives the suspected theft state information and confirms the theft state, the vehicle owner is able to set to prevent the vehicle from being driven using the smart device. This information is then transmitted to the vehicle control unit 200 via the cloud 500, and the vehicle is locked and stop traveling.

Conversely, if the vehicle owner receives the suspected theft state information and confirms that the vehicle is not stolen, the theft prevention control according to the spirit of the present disclosure is released, and the vehicle returns to a normal state.

When the vehicle control unit 200 receives driving prohibition setting information from the smart device 700, the vehicle control unit prevents the vehicle from changing to the key-on state or a drivable state. The simplest way to make it impossible for the vehicle to travel is to disconnect the power supplied to the motor or inverter of the vehicle. Unless the owner releases the driving prohibition, this information remains valid, and the vehicle remains in the undrivable state.

However, in the case where the electric two-wheeled vehicle is being driven or temporarily stopped at an intersection, etc., if the electric two-wheeled vehicle enters the undrivable state, significant risk may be caused, and the owner may also confirm incorrectly that the vehicle is in the theft state. Therefore, it is advantageous that the vehicle is not set to the undrivable state, immediately when the vehicle control unit 200 receives the driving prohibition setting information, and then, when the vehicle is changed to the key-off state (an ignition key is in an off-state), the vehicle is set to the undrivable state. In another implementation, when the speed of the vehicle becomes zero after the vehicle control unit 200 receives the driving prohibition setting information, the vehicle may be immediately set to the undrivable state.

The vehicle is, as described above, set to the undrivable state by using the smart device 700, so that the effectiveness of the theft prevention control according to the spirit of the present disclosure can be improved. This is because when a person stealing the vehicle experiences the theft prevention control according to the spirit of the present disclosure, be/she would determine that there occurs an error in the vehicle and often attempt to restart (reset) the vehicle by turning the ignition key off and then on again. When the restarting is attempted, the vehicle is confirmed to be set to the undrivable state by using the smart device 700, so that the vehicle cannot be used after being stolen.

The present invention can be embodied in other specific forms without changing the technical spirit or essential characteristics thereof by those skilled in the art to which the present invention belongs. Therefore, the foregoing embodiments are illustrative in all aspects and are construed as not limiting the present invention. The scope of the present invention is described by the scopes of the following claims rather than by the foregoing description, and all alternatives, modifications, and variations which are derived from the meaning and scope of the claims and equivalents thereto should be construed as being included in the scope of the present invention.

### REFERENCE NUMERALS

100: Theft Detection Sensing Unit
200: Vehicle Control Unit
220: Theft Determination Unit
240: Theft Prevention Unit
250: Notification Unit
280: Communication Module
300: Inverter
400: Motor
500: Cloud Server

1. A control method for an electric two-wheeled vehicle, the control method comprising:
checking a key-on state and a user authentication state;
determining a suspected theft state if a key-off state occurs or user authentication is released;
controlling an inverter to output a direct current power to a motor when a state of the electric two-wheeled vehicle is determined as the suspected theft state; and
notifying a driver of the suspected theft state.

2. The control method for an electric two-wheeled vehicle of claim 1, wherein, in the determining the suspected theft state, at least one of whether the user authentication is performed, vehicle states, GPS, acceleration sensors, and a back-EMF of the motor is used as a sensor or parameter for detecting the theft.

3. The control method for an electric two-wheeled vehicle of claim 1, wherein the determining the suspected theft state performs at least one of checking whether a moving distance in the key-off state exceeds a predetermined distance using a GPS reception signal, detecting theft movement using a back-EMF of the motor, and detecting the generation of acceleration in a theft situation using an acceleration sensor value.

4. The control method for an electric two-wheeled vehicle of claim 1, wherein the detecting the generation of acceleration in a theft situation determines that the vehicle is in the suspected theft state if instantaneous acceleration is generated in the direction of gravity.

5. The control method for an electric two-wheeled vehicle of claim 1, wherein, in the controlling the inverter to output a direct current power to the motor, all or some of six drive switches of the inverter are continuously turned on with a fixed direct current.

6. The control method for an electric two-wheeled vehicle of claim 1, wherein in the notifying the suspected theft state, information on the suspected theft state of the vehicle is transmitted to a cloud server.

7. A control device for an electric two-wheeled vehicle, the control device comprising:
an inverter which supplies driving power to a motor that moves the vehicle;
a theft detection sensing unit which determines a suspected theft state of the vehicle; and
a vehicle control unit which controls the inverter to output direct current power to the motor when the suspected theft state is recognized.

8. The control device for an electric two-wheeled vehicle of claim 7, wherein the vehicle control unit comprises:
a theft determination unit which determines the suspected theft state of the vehicle;
a theft prevention unit which, when the vehicle is determined to be in the suspected theft state, wakes up the inverter, and then controls the motor with a fixed direct current; and
a notification unit which notifies a driver and related parties of the suspected theft state.

9. The control device for an electric two-wheeled vehicle of claim 7, wherein the theft detection sensing unit comprises at least one of a user authentication means, a GPS receiver sensor, and a 3-axis acceleration sensor.

10. The control device for an electric two-wheeled vehicle of claim 9, wherein the theft determination unit determines that the vehicle is in the suspected theft when the vehicle exceeds a predetermined distance threshold based on received information of the GPS receiver sensor or when an acceleration detected by the acceleration sensor exceeds a predetermined threshold.

11. The control device for an electric two-wheeled vehicle of claim 8, wherein the theft detection sensing unit comprises a forced rotation detection unit which is activated by an electromotive force for forced rotation of the motor and wakes up the inverter.
